(19) United States
(12) Patent Application Publication
(10) Pub. No.: US 2017/0046629 A1
(43) Pub. Date: Feb. 16, 2017

(54) STATISTICS-BASED DATA TRACE CLASSIFICATION

(71) Applicant: HEWLETT PACKARD ENTERPRISE DEVELOPMENT LP, Houston, TX (US)

(72) Inventors: Philipp REINECKE, Bristol (GB); Brian Quentin MONAHAN, Bristol (GB); Jonathan GRIFFIN, Bristol (GB)

(73) Assignee: HEWLETT PACKARD ENTERPRISE DEVELOPMENT LP, Houston, TX (US)

(21) Appl. No.: 15/306,704

(22) PCT Filed: Apr. 25, 2014
(86) PCT No.: PCT/US2014/035483

§ 371 Date: Oct. 25, 2016

(51) Int. Cl. G06N 99/00; H04L 29/06; G06N 7/00

(52) U.S. Cl. CPC G06N 99/005; G06N 7/005; H04L 63/1416

(57) ABSTRACT

According to an example, statistics-based data trace classification may include generating sets of training data traces from training data information by assigning a subset of the training data information that has a predetermined property with a first label and assigning another subset of the training data information that does not have the predetermined property with a second label. A trained trace classifier may be generated to detect whether or not a set of input data traces satisfies the predetermined property. The trace classifier may be trained to learn the predetermined property from a statistical data object determined from the sets of the training data traces, and the first and second labels related to the sets of the training data traces.

### BACKGROUND

Systems monitoring is typically a process within a distributed system for collecting and storing data related to the state of the distributed system. With respect to systems monitoring and, more specifically, to malware detection, a typical problem is to be able to characterize the current state or status of a system, such as the presence of malware, purely from observations. For systems where the failure modes of the system are well understood by design, and where components are designed to have specific failure modes, systems monitoring is typically based on the monitoring of specific data patterns from a set of data traces, one for each variable monitored. With respect to systems monitoring, data traces may include a series of variables or attributes, each including a finite sequence of numerical measurements or values produced by a sensor.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a statistics-based data trace classification apparatus, according to an example of the present disclosure;

FIGS. 2A and 2B illustrate pseudo-code for a genetic process for implementing aspects of the statistics-based data trace classification apparatus, according to an example of the present disclosure;

FIG. 3 illustrates a data trace for random variable kbd_evts, according to an example of the present disclosure;

FIG. 4 illustrates raw data for a scenario (i.e., a set) containing several data traces, according to an example of the present disclosure;

FIG. 5 illustrates supported statistics, according to an example of the present disclosure;

FIG. 6 illustrates pseudo-code representing a trace classifier, according to an example of the present disclosure;

FIG. 7 illustrates pseudo-code that illustrates computation of a fitness function of a genome, according to an example of the present disclosure;

FIG. 8 illustrates training and operation phases of the statistics-based data trace classification apparatus, according to an example of the present disclosure;

FIG. 9 illustrates a method for statistics-based data trace classification, according to an example of the present disclosure;

FIG. 10 illustrates further details of the method for statistics-based data trace classification, according to an example of the present disclosure; and

FIG. 11 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

With respect to systems monitoring, while some types of monitoring may be based on specific data patterns, with respect to the application of systems monitoring to malware detection, malware is typically designed to evade detection, and therefore does not exhibit known signals of its presence. Malware typically includes machine readable instructions that are used to disrupt computer operation, gather sensitive information, or gain access to private computer systems, without the consent of the system or information owners. Malware typically appears in the form of code, scripts, active content, and other machine readable instructions, and is typically injected into a system in a covert manner by an adversary. The malware may maintain its own function by stealthy means. Nonetheless, however stealthy the malware is, the malware still exploits and makes use of the host system to perform its activities. These activities affect data traces produced by the host system, potentially resulting in recognizable patterns that may be used for detection. Thus, there may be relevant behavioral patterns of systems. However, these patterns are generally not known beforehand, and therefore, may need to be learned from the data trace in situ.

According to examples, a statistics-based data trace classification apparatus and a method for statistics-based data trace classification are disclosed herein. According to an example, the apparatus may include a training data trace generation module that is executed by at least one processor to generate sets of training data traces from training data information by assigning a subset of the training data information that has a predetermined property with a first label, and assigning another subset of the training data information that does not have the predetermined property with a second label. A single data trace is a finite sequence of numerical measurements or values for a particular random variable (e.g. kbd_evts; as described herein) and is typically produced by a sensor. Data information may include any type of information that may be analyzed to generate a data trace or a set of data traces (for various sensors/random variables). As described herein, a predetermined property may be related to whether data information represents malware, an operating system, or an application start-up. A label may represent an indicator that is used to determine whether data information does or does not have a predetermined property.

The apparatus disclosed herein may further include a trace classifier generation module that is executed by the at least one processor to generate a trained trace classifier to detect whether or not a set of input data traces satisfies the predetermined property. The trace classifier may be trained to learn the predetermined property from a statistical data object determined from the sets of the training data traces, and the first and second labels related to the sets of the training data traces. A trace classifier may include a logical function (or predicate) that takes any given set of data traces as input, and assigns a Boolean value to it by generating a first output if the set of the input data traces satisfies the predetermined property and a second value if the set of the input data traces does not satisfy the predetermined property. According to an example, the Boolean value may include a 1 or a 0, which may respectively represent a TRUE that means accept and a FALSE that means reject. A statistical data object may represent the characteristics of a set of data traces in terms of statistics of the attributes contained therein. These statistics may be determined from the sequences of numerical measurement data for the attributes. Statistics may include statistics that are determined from multiple attributes.

The apparatus disclosed herein may further include an analytics module that is executed by the at least one processor to use the trained trace classifier to detect whether or not the set of the input data traces satisfies the predetermined property. Thus, the analytics module may use the trained trace classifier to detect whether or not the set of the input data traces represents, for example, malware, an operating system, or an application start-up.

According to an example, the apparatus and method disclosed herein may implement learning of trace classifiers that detect the presence of malware based on statistics of traces of quantitative system monitoring data. Generally, the apparatus and method may be based on genetic processes that are used to learn and determine the statistics-based trace classifier from sets of training data traces. The apparatus and method disclosed herein may take a supervised learning-by-example approach, fully label given sets of training data traces, and divide the sets of training data traces into those exhibiting a desired property and those that do not exhibit the desired property. With respect to the genetic processes used for the apparatus and method disclosed herein, the classification may involve statistical properties of a given trace (e.g., mean, median, variance, quantiles, autocorrelation, etc.), and thus include a reduced dependency upon the literal data trace itself. The generated trace classifiers may be characterized by statistical attributes. Thus, a set of data traces may be accepted or rejected based upon the particular statistics that the set of data traces itself possesses. Thus, the generated trace classifiers are insensitive to statistically insignificant variations in the set of data traces.

The apparatus and method disclosed herein may characterize a set of data traces of interest via an learning process that is driven from training sets of example data traces. The apparatus and method disclosed herein may generate trace classifiers from the given sample training sets of data traces that are divided into an accepting set (e.g., designated by a Boolean 1 as described herein) and a rejecting set (e.g., designated by a Boolean 0 as described herein). The initial partitioning of given training data traces into accepting and rejecting sets may be performed via an a priori out-of-band context-dependent process.

For the apparatus and method disclosed herein, the trace classifiers may generalize the given sets of training data traces by producing a trace classifier that correctly classifies all or a large part of the sets of training data traces. In this regard, since a trained classifier may not be uniquely determined, as described herein, the apparatus and method disclosed herein may implement additional randomized choices to produce a resulting trace classifier.

For the apparatus and method disclosed herein, the trace classifiers may be predicates over an input set of data traces that is based upon derived attributes such as statistical characteristics of the given set of input data traces. This means that the trace classifiers depend upon particular statistical quantities determined from the set of data traces, and not directly upon the particular data values that happen to occur in the set of the data traces. In this manner, the trace classifiers may broadly generalize the training set that they are based upon, since any statistically irrelevant variations in the set of input data traces are disregarded.

For the apparatus and method disclosed herein, with respect to malware detection, as described herein, the quantitative system data is typically either already collected (e.g., load levels), or may be obtained by instrumentation of existing components (e.g., interarrival times of hard-disk accesses observed in the hypervisor). Therefore, data collection may need minimal changes to a system. The detection approach of utilizing quantitative data may provide further robustness against evasion measures in malware, compared to signature-based approaches, since malware typically performs actions that may leave traces in the data in order to fulfill its function.

The apparatus and method disclosed herein may be applied to a variety of technologies, such as, for example, operating-system detection, application start-up detection, malware detection, etc. Generally, the apparatus and method disclosed herein may be applied to any areas where data traces may be analyzed to determine a characteristic of a system related to the data traces. With respect to operating-system detection, the apparatus and method disclosed herein may distinguish between different operating systems, for example, based on interarrival times of disk-accesses during the bootup-process through monitoring instrumentation in a hypervisor. In this example, booting a first operating system may constitute a positive observation, while booting a different operating system may constitute a negative observation. For the example of application start-up detection, the trace classifier may similarly operate on disk-access interarrival times obtained through the hypervisor. In this example, startup of a predetermined application may constitute a positive observation. For the example of malware detection, data traces for the behavior of a system with malware may be determined by monitoring an infected system for a fixed amount of time, for example, for interarrival times between events. The data traces may be used to determine trace classifiers, which may then be used for malware detection.

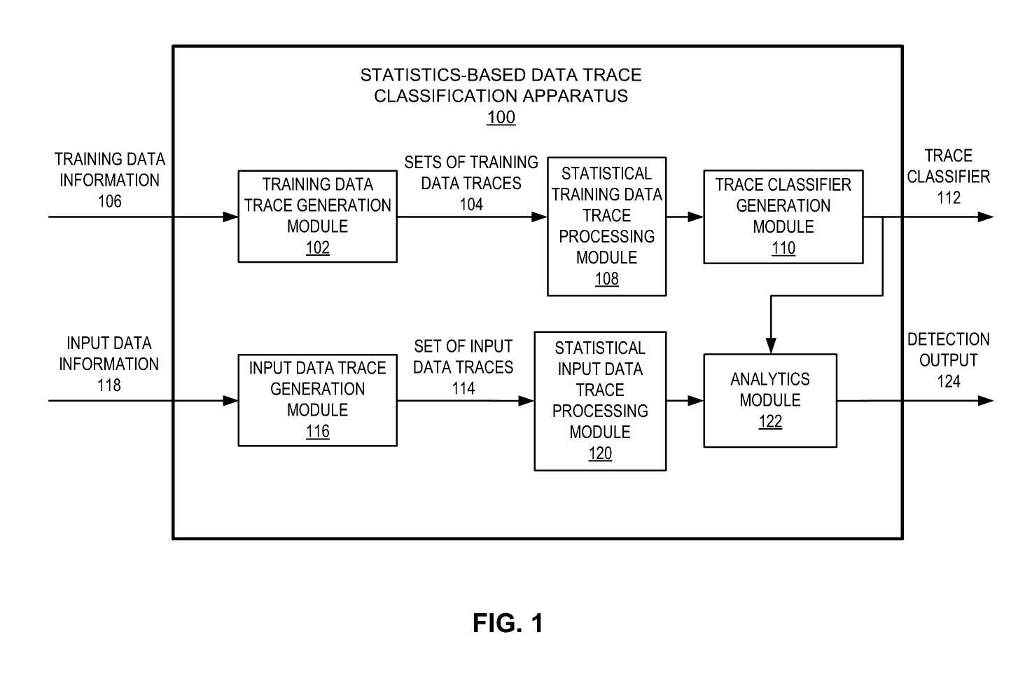

FIG. 1 illustrates an architecture of a statistics-based data trace classification apparatus (hereinafter also referred to as “apparatus 100”), according to an example of the present disclosure. Referring to FIG. 1, the apparatus 100 is depicted as including a training data trace generation module 102 to generate sets of training data traces 104 from training data information 106 by assigning a subset of the training data information 106 that has a predetermined property with a first label and assigning another subset of the training data information 106 that does not have the predetermined property with a second label.

A statistical training data trace processing module 108 is to determine a statistical data object from the sets of the training data traces 104 by determining statistics values related to the sets of the training data traces 104. As described herein, the statistics values may include mean, variance, median, squared coefficient of variation (SCV), autocorrelation, and/or quantile.

A trace classifier generation module 110 is to generate a trained trace classifier 112 to detect whether or not a set of input data traces 114 satisfies the predetermined property. The trace classifier 112 may be trained to learn the predetermined property from the statistical data object determined from the sets of the training data traces 104, and the first and second labels related to the sets of the training data traces 104.

An input data trace generation module 116 is to generate the set of the input data traces 114 from input data information 118.

A statistical input data trace processing module 120 is to determine another statistical data object from the set of the input data traces 114 by determining statistics values related to the set of the input data traces 114. As described herein, the statistics values may include mean, variance, median, SCV, autocorrelation, and/or quantile.

An analytics module 122 is to use the trained trace classifier 112 to detect whether or not the set of the input data traces 114 satisfies the predetermined property. The results of the analytics module 122 may be output as a detection output 124. As described herein, the predetermined property may be related to operating system detection, application start-up detection, and/or malware detection.

The modules and other elements of the apparatus 100 may be machine readable instructions stored on a non-transitory computer readable medium. In this regard, the apparatus 100 may include or be a non-transitory computer readable medium. In addition, or alternatively, the modules and other elements of the apparatus 100 may be hardware or a combination of machine readable instructions and hardware.

For the apparatus 100, a genetic process may be defined as being genetic if it embodies a certain evolutionary strategy to the way that solutions are sought and discovered by using it. A genetic process may be a particular search heuristic for successively generating potential solution candidates. Thus, a genetic process may either complete successfully by finding a sufficiently satisfactory solution, or fail by, for example, failing to generate good enough candidates, or by running out of time/resources. A genetic process may be a form of bounded evolutionary search in which a randomized population of individuals (denoted the initial generation) is iteratively transformed by operations on individuals involving selection and inheritance, and more explicitly, the primary genetic operations upon individuals of mutation and crossing-over to produce subsequent generations. The individuals including each generation may be designated as data structure instances that are capable of representing the solutions being searched for.

The process of evolution may be governed by a fitness function over individuals that assign a quantitative value representing how well-adapted each individual is. In terms of the problem to be solved, this ranking may determine how adapted the individual is to the solution being sought, that is, how well the individual solves the problem. The value of the fitness function may then control how the next generation is produced from contributions from the currently best adapted individuals.

In complex problems addressed with genetic processes, this fitness function may involve assessing and evaluating how well a process or activity of interest performs at achieving a task, where the process of interest is determined by the individual's data structure representation. Generally, this assessment may be expensive in terms of computational resources and effort, as it may involve some element of large scale simulation under a competitive tournament situation between numbers of individuals.

With respect to genetic processes, an individual genotype may represent individuals (in terms of data structures), and generally those particular attributes that constitute each individual's genotype or genome. The genome may include those attributes or fields that define and characterize each individual uniquely. Genomes may be used to produce further individuals, for example, by the genetic operations of crossing-over and mutation. Crossing-over may include a randomized mixing of particular attributes from existing parent individuals to produce a new individual. Mutation may include randomized modifications of particular attributes that characterize a specific individual. With respect to genetic processes, a fitness function over individuals may be used to quantitatively assess how well adapted each individual is, with respect to the solutions(s) being sought. The fitness function may capture solutions in terms of the best values that may be witnessed by specific individuals. In certain problem contexts, the fitness function may involve conducting a competitive analysis between individuals, in order to rank the individuals. The outcome of executing a particular genetic process may depend on the space of individuals that may be produced by successive randomized generations, beginning from a randomized initial population. Genetic processes may behave in a highly non-deterministic manner due to the large number of randomized decisions that need to be made as part of their execution.

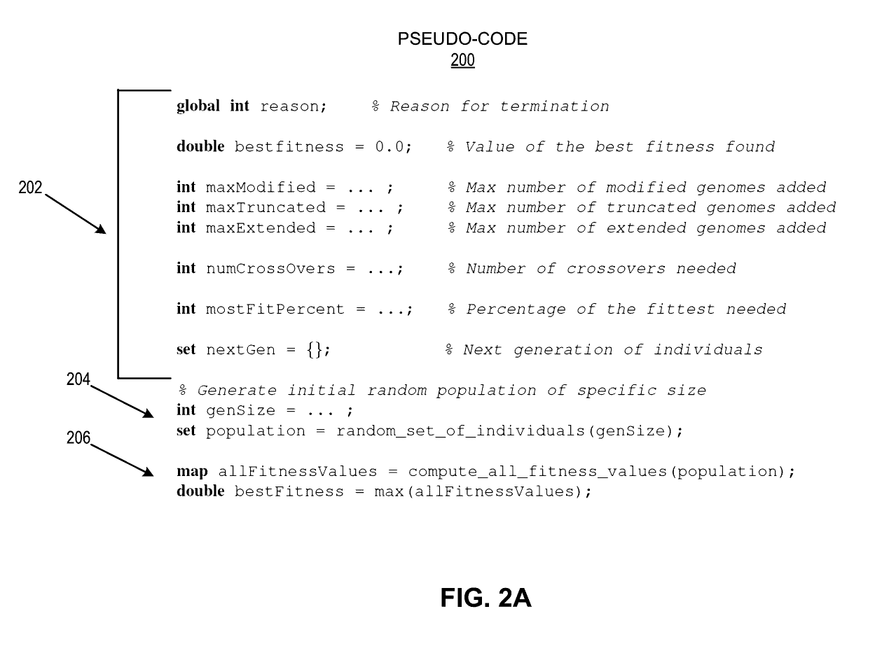

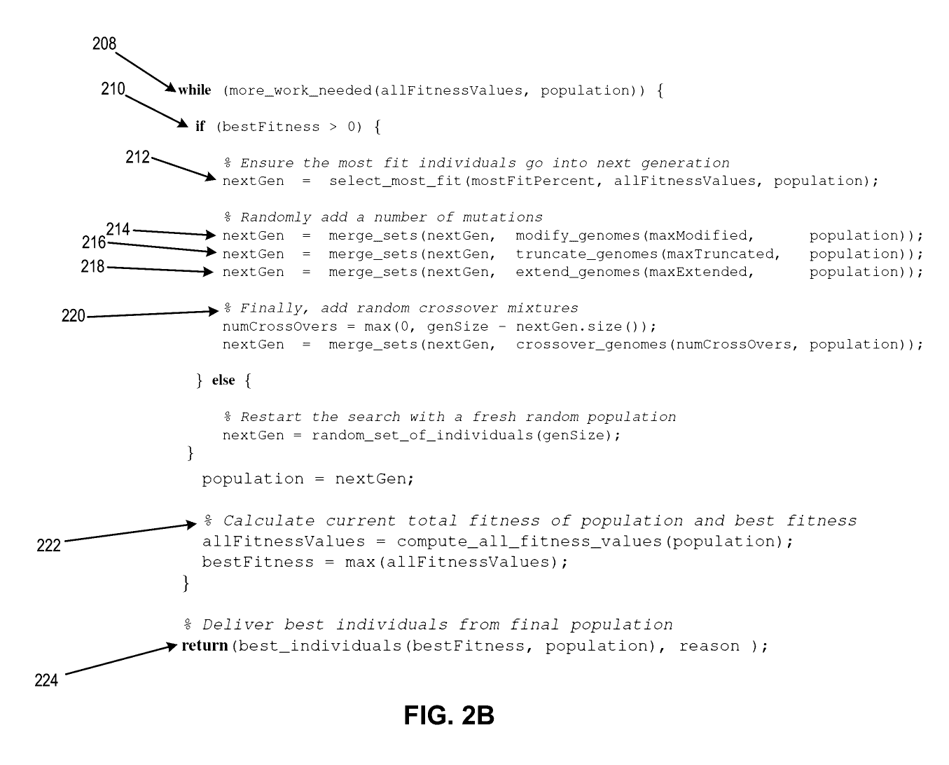

For the apparatus 100, FIGS. 2A and 2B illustrate pseudo-code 200 for a genetic process for implementing aspects of the apparatus 100, according to an example of the present disclosure.

Referring to FIGS. 2A and 2B, at 202 various constants and structures are initialized, including the initial population (chosen randomly) at 204, followed by an initial determination of all fitness values at 206. At 208, a determination is made as to whether more work remains to be done. As described herein, the predicate more_work_needed depends upon the fitness scores and the current population. At 208, the predicate more_work_needed (allFitnessValues, population) may indicate if further work needs to be performed, returning true to continue and false to stop. At 210, bestFitness is checked to determine if it has a value greater than zero. If bestFitness has a zero value, then the population is not useful, and the search is restarted and a fresh population is chosen randomly. Otherwise, the current population is used as the basis for generating the next generation. At 212, the topmost percentage of individuals is retained for the next generation. At 214, 216, and 218, a series of random mutation steps are performed upon the population, producing further individuals which are then added and merged into the next generation. For 214, with respect to modification, maxModified randomly chosen genomes are modified. At 216, with respect to truncation, max Truncated randomly chosen genomes have their genomes truncated by cutting out some number of the atomic formulae and/or clauses. At 218, with respect to extension, maxExtended randomly chosen genomes have their genomes extended by adding some number of randomly generated atomic formulae and/or clauses. The mutation stage at 214-218 may be followed by a randomized mixing stage at 220 in which a crossing-over operation may be performed to generate enough individual genomes to make the population size again be genSize. The mutation operations and the crossover operation may select the candidates that are used to produce the new population randomly. For each genome, the probability of being selected may be proportional to its fitness. This may result in a tendency to improve the fitness of the population, as in each step fitter genomes are more likely to be part of the new population. Having defined the new population, at 222, the set of all fitness values and the best fitness value may be computed, before returning to the start of the loop again at 224. Thus, at 224, the best individuals (i.e., a single trace classifier 112, or a plurality of trace classifiers 112) may be returned, based on whether a single trace classifier 112, or a plurality of trace classifiers 112 are requested.

The genome may represent the trace classifier 112 in disjunctive form, conjunctive form, disjunctive normal form (DNF), or conjunctive normal form (CNF). The atomic terms are comparisons defined on the statistics of the data trace. The atomic terms may include a left-hand side, a right-hand side, and a comparison operator. The left-hand side and the right-hand side may include statistics of the data trace (as defined in the statistical data object), of numeric values, and/or of arithmetic combinations of these. The comparison operators may include smaller than, smaller/equal, equal, larger/equal, and larger than. The genome may be modified structurally, i.e., adding/removing/exchanging atoms. The genome may also be modified on the atomic level, by modifying the left-hand side, right-hand side, and/or the comparison operator. Modifications on the left-hand side and right-hand side of an atomic term may replace statistics, numeric values, and/or arithmetic operations with other statistics, numeric values, and/or arithmetic operations. Modifications of the comparison operator may replace the comparison operator by another comparison operator. Due to the form of the genome, any modification will result in a genome that is again a genome of the given form.

Based on the randomized nature of genetic processes, it may be challenging to have a definitive and effective test for optimal stopping of the loop at 208. Thus, it may be challenging to use a single check that works for all possible uses of the genetic process for the apparatus 100. The particular test used may consider a combination of factors that include a quality of the trace classifiers produced being sufficiently high to be useful (this may be tested by systematic determination of various metrics such as true positive rate (TPR), false positive rate (FPR), etc.), has there been little or no improvement of fitness over some past fixed number of generations (i.e., has the search plateaued), and has the number of generations exceeded a maximum number permitted. If any of these factors are true, then a global reason variable may be assigned based on the check that is true, and the loop at 208 may be stopped. The loop at 208 terminates since eventually the number of generations exceeds the maximum number of generations permitted. Once the loop at 208 terminates, the best individual (e.g., a single trace classifier 112) that is determined from the final population, or a subset of the best individuals (e.g., a plurality of trace classifiers 112), is returned. Since a trace classifier that is produced may not completely classify the given training set correctly, the reason variable may need to be examined after termination, and the trace classifier may need to be tested for its usefulness, for example, if the loop at 208 finishes due to exceeding the maximum number of generations.

With respect to the pseudo-code 200, a pseudo-random generator may deliver a succession of random integers and floating point numbers. The pseudo-random sequence that is returned by the pseudo-random generator may include a large enough period so that the pseudo-random generator state does not effectively repeat during deployment. A source of high-quality random numbers generator may also be used.

With respect to random variables, data traces, and scenarios, the raw data analyzed by the apparatus 100 may be of a form as described herein. Further, the raw data may be reduced to a number of specific statistics for each random variable being measured within the raw data.

For the apparatus 100, a random variable may represent the measurements of a numerical attribute taken from a particular computer system, such as, for example, the time of a keyboard event, the number of keyboard events per unit time interval, the number of disk reads per unit time interval, the number of internet protocol (IP) packets received on a given port, the number of IP packets sent on a given port since reboot, the inter-arrival time between different writes to disk, the inter-arrival time between different reads from disk, the number of processes running per unit time interval, and/or amount of random access memory (RAM) memory allocated per unit time interval.

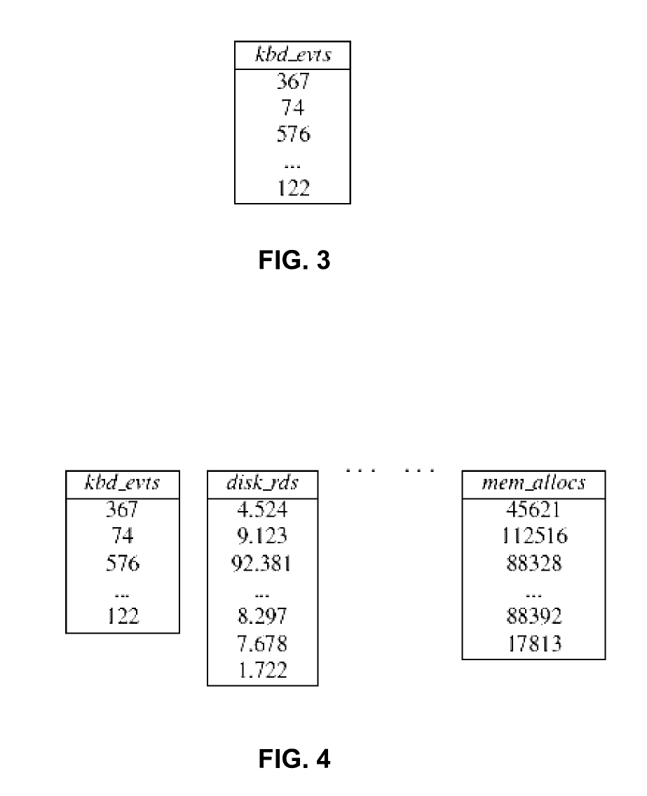

As described herein, a single data trace is a finite sequence of numerical measurements or values for a particular random variable (e.g. kbd_evts; as illustrated in FIG. 3), and may be produced by a sensor. Such measurements or values may additionally record the time that these readings are taken. Thus, the measurements or values may or may not be recorded with corresponding timestamps without impacting the statistics-based data trace classification described herein. A scenario (or run) may represent a collection or set of data traces, one for each random variable of interest, and is illustrated by FIG. 4. Scenarios may record a specific given set of random variables. Each data trace may include a sufficient number of readings for the computed statistics to be meaningful. A scenario or run may represent a sequence of readings for certain specific random variables. Each data trace for the random variables in a scenario may have the same or different lengths. Moreover, the data entries may also be synchronized time-wise, or instead, the data entries may be taken at convenient times. Each scenario may be assigned a label or classification (denoted by δ) which is either Boolean 0 or 1. The Boolean 0 value may indicate that the scenario does not possess the desired property of interest, whereas a Boolean 1 value may indicate the opposite (e.g., that the scenario does possess the desired property of interest).

With respect to derivation of statistics from the raw data, the raw data for each scenario may be processed to determine the values of certain particular statistics for each random variable of interest. Typically, the statistics computed for each random variable in a scenario may include mean, variance, median, SCV, and quantile. The mean may represent the average value of the data entries for the random variable. The variance may represent the variance of the data entries or samples for the random variable. The median may represent the median value of the data entries for the random variable. The SCV may represent the variance divided by the mean (squared), which is independent of the units of measurement, and represents a scale-insensitive measure of how spread the values are within the sample. The SCV may be defined when the mean is non-zero, and will also tend to infinity as the mean approaches zero. The quantile (90%, 95%, and 99%) may represent the quantile values of the random variable for 90%, 95%, and 99%.

The apparatus 100 may also determine the autocorrelation factor (ACF) for a number of different lags (or shifts). The ACF may represent the cross-correlation of the sequence of data values of itself against a version of the same sequence shifted by a particular number of entries (i.e., the lag). Autocorrelation may detect the presence of repeating patterns or periodic signals. As such, the autocorrelation may measure the amount of delayed echo present in a signal. The data value measurement may be sampled at a constant or fixed rate. When using the ACF, the length of the input raw data traces may be constrained. For example, if the classifier uses an ACF with a lag of 7, then the raw data traces may need to have a length of at least 7 for this to be meaningful.

The statistics computed for each scenario may be used to produce a corresponding statistics data object which may either then be passed for training purposes (with appropriate labeling), or passed to a statistics classifier (e.g., the trace classifier) for assessment purposes.

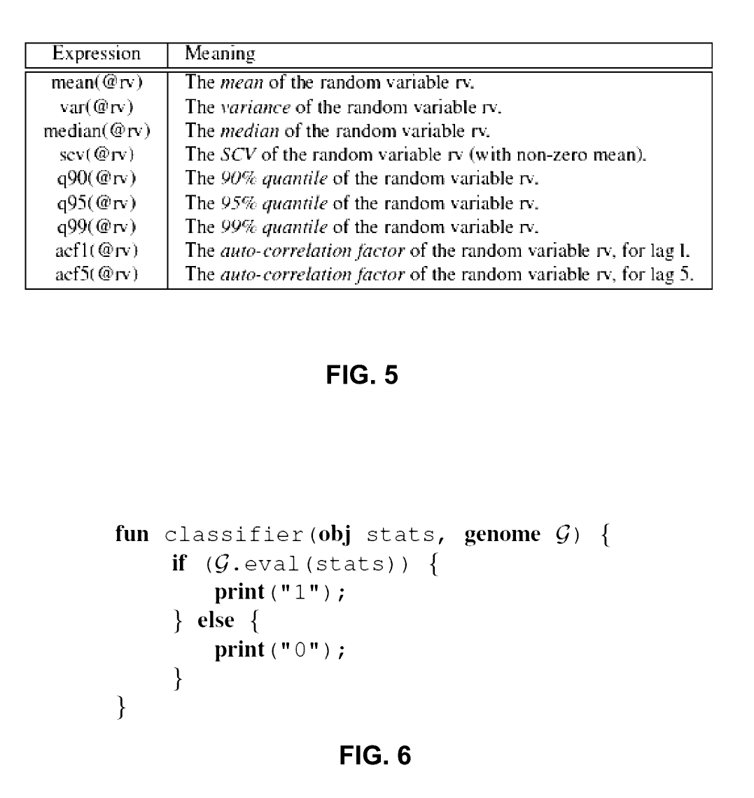

FIG. 5 illustrates supported statistics, according to an example of the present disclosure. Specifically, the various terms denoting the statistics that are used over random-variables are shown in FIG. 5. If other statistics or numerical feature attributes are needed, the statistics of FIG. 5 may be extended by adding corresponding terms that would denote the particular values of the attribute for a given random variable.

With respect to the structure of the trace classifier 112, the trace classifier produced by the apparatus 100 may be in the form of machine readable instructions that are in an appropriate programming notation. The behavior of the trace classifier may be determined by the genome as a Boolean predicate function denoted by g. The pseudo-code representing the trace classifier 112 may be specified as illustrated in FIG. 6.

The genome used for the pseudo-code 200 is a logical expression that qualifies the statistical features extracted from a scenario. This logical expression may be generated to make use of the statistical feature data (e.g., means and variances) for each of the random variables in a current scenario. As a result, the logical expression defines some predicate over the scenario, and will evaluate either to Boolean 1 (e.g., TRUE), meaning the scenario possesses this property, or to Boolean 0 (e.g., FALSE), meaning the scenario does not possess this property. The training phase for the apparatus 100 may improve upon how well this property given by the logical expression approximates the desired property of interest.

The Boolean genome may include atomic logical expressions built from arithmetic combinations involving literals and statistics on random variables. These logical expressions may include the syntactic form:

A::=(tm_{L}op tm_{R}) Equation (1)

For Equation (1), the left-hand side tm_{L}::=f (@rv) is a statistic f on the random variable @rv, and op::=‘<’|‘≦’|‘=’|‘≧’|‘>’ is a comparison operator. For Equation (1), the right-hand side is:

$$\begin{matrix}{tm}_{R} :: = c \\ \vert plus ( f ( @ rv ) , c ) \\ \vert plus ( f ( @ rv ) , g ( @ {rv}^{′} ) ) \\ \vert minus ( f ( @ rv ) , c ) \\ \vert minus ( c , f ( @ rv ) ) \\ \vert minus ( f ( @ rv ) , g ( @ {rv}^{′} ) ) .\end{matrix}$$

Thus, tm_{R} is either a literal cε [symbol] , or the sum (plus(.,.)), or the difference minus (.,.) of either a static f (@rv), a literal cε [symbol] , or two statistics f,g on two random variables @rv, @rv′. For example, the atomic logical expression mean(@disk-access-iat)≦5.78 denotes the condition that the mean of the random variable @disk-access-iat in the current scenario is not larger than 5.78. These atomic formulae are Boolean-valued, and are then connected to other formulae using the Boolean connectives such as or and and to form the genome. To facilitate the various genetic operations of crossing-over and mutation, the Boolean genome expression may be structured in the form of a simple conjunction, DNF, simple disjunction, or CNF.

With respect to simple conjunction, a formula in simple conjunctive form may include a series of atomic formulae joined by the and operator (i.e., A₁ and A₂ and A₃ and . . . and Aₙ). This formula evaluates to TRUE if all conditions are met, and false otherwise. Its length may be defined as the number of atomic terms n.

With respect to DNF, a formula in DNF may include of a series of and clauses (i.e., formulae in simple conjunctive form) joined by the or operator as follows:

$$\begin{matrix}( {A}_{11} and {A}_{12} and & … & and {A}_{1 {n}_{1}} ) or \\ ( {A}_{21} and {A}_{22} and & … & and {A}_{2 {n}_{2}} ) or \\ & ⋮ & \\ ( {A}_{m 1} and {A}_{m 2} and & … & and {A}_{1 {n}_{m}} ) .\end{matrix}$$

A formula in DNF evaluates to TRUE if any of the m conditions described by an and clause is met, and false otherwise. Its length may be defined as the number of and clauses m.

With respect to simple disjunction, a formula in simple disjunctive form may include of a series of atomic formulae joined by the or operator (i.e., A₁ or A₂ or A₃ or . . . or Aₙ). This formula evaluates to TRUE if any condition is met, and false otherwise. Its length may be defined as the number of atomic terms n.

With respect to CNF, a formula in CNF may include of a series of or clauses (i.e., formulae in disjunctive form) joined by the or operator as follows:

$$\begin{matrix}( {A}_{11} or {A}_{12} or & … & or {A}_{1 {n}_{1}} ) and \\ ( {A}_{21} or {A}_{22} or & … & or {A}_{2 {n}_{2}} ) and \\ & ⋮ & \\ ( {A}_{m 1} or {A}_{m 2} or & … & or {A}_{1 {n}_{m}} ) .\end{matrix}$$

A formula in CNF may evaluate to TRUE if all of the m conditions described by or clauses are met, and false otherwise. Its length may be defined as the number of and clauses m.

For the apparatus 100, the choice between these forms may be guided by considerations of the quality of the trace classifiers 112, and of the performance in evaluating the trace classifiers 112. For example, the DNF form may be used since it combines high expressiveness and parallelizable efficient evaluation. The logical formulae produced as genomes may be further optimized by eliminating redundant terms such as any repeated atomic formulae occurring in the same clause, or clauses that evaluate to FALSE or TRUE.

At each step, the genetic process for the apparatus 100 may create a new population based on the previous population. The individuals in the new population may evolve from those in the old population through mutation and crossover operations. The candidates for each operation may be selected randomly with selection probability proportional to the fitness of the individual.

With respect to random mutation, random mutations of the genome may involve several kinds of modification to the genome itself. As described herein, the genome is a logical expression in normal form involving atomic formulae including equalities and comparisons between arithmetic terms. The kinds of modification that may be made include extension, truncation, modifying literals, and modifying comparisons. Extensions may include adding a randomly generated clause or atomic formula within a clause. Truncation may include removing a randomly chosen clause or atomic formula within a clause. Modifying literals may include changing an existing atomic formula by tweaking literals or changing the arithmetic expressions used. For example, for the atomic formula mean(@disk-access-iat)≦5:78, this formula may be subjected to random modification and replaced by mean(@disk-access-iat)≦plus(mean(@network-packet-iat), 13.93). Modifying comparisons may include changing the comparison operator used in a randomly selected atomic formula. Since the logical negation of an atomic formula may be effected by changing the comparison operator, this particular kind of mutation may subsume the idea of turning an atomic formula into its negation. For example, for the atomic formula mean(@disk-access-iat)≦5:78, the comparison may be changed from ≦ to > to yield mean(@disk-access-iat)>5.78. Similar mutations may radically change the logical behavior of the modified atomic formula. Applying a random mutation to a genome produces another genome in the same form.

With respect to crossing-over, generally, the operation of crossing-over is one of mixing-up fragments of genomes from one or more parent genomes and then combining these fragments to form two new offspring genomes. The specifics of the crossover operation depend on the representation for the genome, as follows. With respect to simple conjunctive or disjunctive form, the following genomes are in simple conjunctive form, where n₁≦n₂.
g₁=A₁ and A₂ and . . . and Aₙ_{₁}
g₂=B₁ and B₂ and . . . and Bₙ_{₂}
   A random crossover point iε[1,n₁] may be selected. The offspring genomes may then be specified as:
g₁=A₁ and A₂ and . . . and Aᵢ₋₁ and Bᵢ and . . . and Bₙ_{₂}
g₂=B₁ and B₂ and . . . and Bᵢ₋₁ and Aᵢ and . . . and Aₙ_{₁}
   That is, the tails of the genomes g₁ and g₂ beyond the crossover point i are swapped. For the simple disjunctive form, this operation may be performed in an analogous manner.

With respect to disjunctive and conjunctive normal form, Gᵢ and Hᵢ may denote terms in simple conjunctive form, where g₁ and g₂ are two genomes in DNF as follows:
g₁=G₁ or G₂ or . . . or Gₘ_{₁}
g₂=H₁ or H₂ or . . . or Hₘ_{₂}
   Assuming m₁≦m₂, a random crossover point iε[1,m₁]. The offspring genomes may then be specified as:
g₁=C₁ and C₂ and . . . and Gᵢ₋₁ and Hᵢ and . . . and Hₘ_{₂}
g₂=H₁ and H₂ and . . . and Hᵢ₋₁ and Gᵢ and . . . and Gₘ_{₁}
   For the offspring genomes, the tails of the genomes g₁ and g₁₂ beyond the crossover point i are swapped. For the conjunctive normal form, this operation may be performed in an analogous manner, with Gᵢ and Hᵢ referring to terms in simple disjunctive form.

As in the case of mutation, this crossing-over operation may take genomes in one form and produce new offspring genomes in the same form. Therefore, any transformative conversions to re-establish the previous form of the expression may not need to be performed.

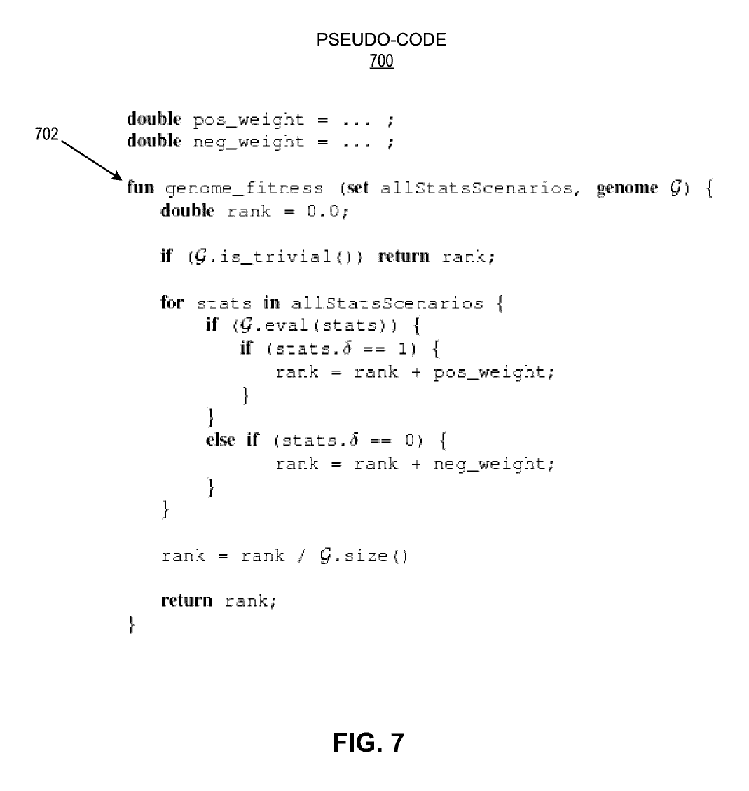

With respect to assessment of fitness of the genome, the training process for the apparatus 100 as described herein may consider the way that each genome is ranked and assessed. One aspect may be to determine trace classifiers 112 that characterize the desired property as defined by the training statistics scenarios and their labeling. This may be performed by testing the current genome against all of the training current genome scenarios and their respective labeling. For example, FIG. 7 illustrates pseudo-code 700 that illustrates computation of a fitness function of a genome, according to an example of the present disclosure. Referring to FIG. 7, at 702, the set allStatsScenarios may contain all the information about the training statistics scenarios, including the labeling. If the genome is trivial (i.e., its length is zero), it cannot distinguish between scenarios, and therefore has a fitness 0. Otherwise, the ranking value for the genome may be determined by adding weighting values for each correct classification (i.e., a match between the classification by the genome and the associated labeling of a statistics scenario). The ranking value may be divided by the size of the genome to produce the final ranking value, in order to prefer shorter genomes over longer ones. The weighting values may be used to adapt the selection process to specific needs. For example, the weighting values may be used to express that correct positive classifications are much more relevant than correct negative classifications.

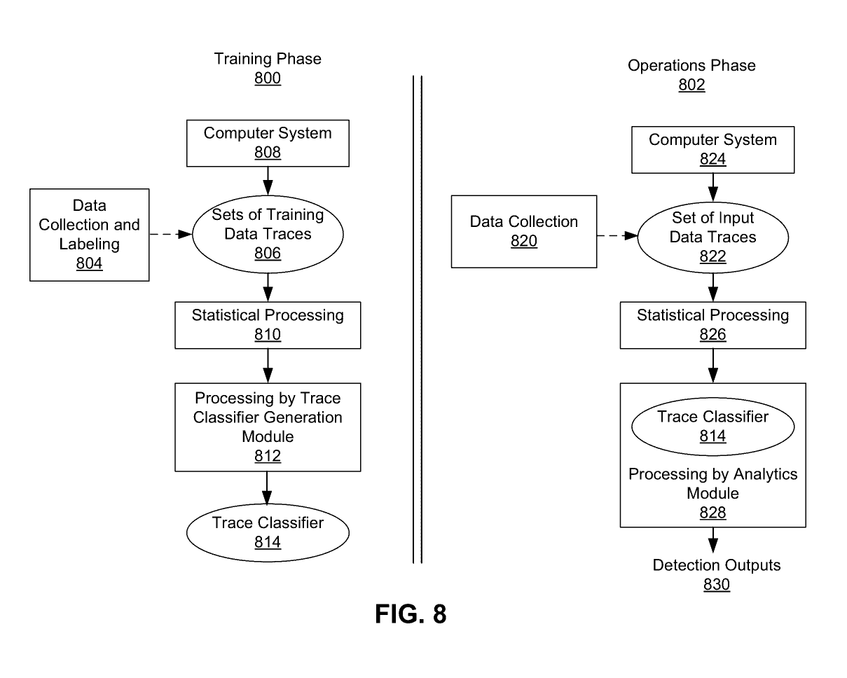

FIG. 8 illustrates training and operation phases 800, 802, respectively, of the apparatus 100, according to an example of the present disclosure. For an example of an application of the apparatus 100 for systems monitoring and malware detection based on signal analysis, the apparatus 100 may include two phases, the training phase 800, where the trace classifier 112 is obtained, and the operations phase 802, where the trace classifier 112 is employed to detect malware.

Referring to FIGS. 1 and 8, the training phase 800, which is described in further detail below, may generally include a data collection and labeling phase at 804 to generate the sets of the training data traces 104 at 806 for a computer system 808, a statistical processing phase at 810, processing by the trace classifier generation module 110 at 812, and generation of a trace classifier 112 (or a plurality of trace classifiers) at 814.

Specifically, with respect to the data collection and labeling phase at 804, the training data information 106 may be collected while the computer system 808 of interest is operating. Because of the tightly controlled manner in which this computer system 808 is executed under training conditions, it is known precisely at which point the computer system 808 has the property that is to be detected. For example, such a property is whether the computer system 808 is currently infected by a particular kind of malware. Accordingly, a subset of the training data information 106 sampled is then labeled as either having label δ=1 when the computer system 808 has the property, or as having label δ=0 when the computer system 808 does not have the property. The data collected and labeled at 804 may be used to generate the sets of the training data traces 104 at 806.

With respect to the statistical processing phase at 810, labeled data information from the sets of the training data traces 104 at 806 may be used to compute various statistics. These statistics values may then be embodied within a statistics data structure object, one for each data information sample (or scenario). These statistics data objects, together with their associated labeling, may be gathered and then forwarded for processing by the trace classifier generation module 110 at 812.

At 812, the trace classifier generation module 110 may take all of the given statistics data objects and associated labeling, and process them to, if possible, generate a trace classifier 112 at 814 in the form of a Boolean-valued expression. The trace classifier 112 may be rendered within a suitable programming language such as R, for use within the operations phase 802. For the training process to succeed, at least one statistics data object labeled δ=1 and at least another object labelled δ=0 may be needed. When successful, the machine readable instructions for the trace classifier 112 may represent a logic function that takes some given statistical data object as input. Given this input, the machine readable instructions for the trace classifier 112 may then produce as output either a 1 (for having the property), or a 0 (for not having the property). As a result of the training process, the generated trace classifier 112 may take an input statistics data object and then return either 1 or 0. The machine readable instructions for the trace classifier 112 may then be used for deployment into the operations phase 802.

Using the trace classifier 112 generated in the training phase 800, the operations phase 802, which is described in further detail below, may generally include a data collection phase at 820 to generate the set of the input data traces 114 at 822 for a computer system 824, a statistical processing phase at 826, processing by the analytics module 122 at 828 (e.g., the analytics phase), and detection outputs 124 at 830.

Specifically, with respect to the data collection phase at 820, the input data information 118 may be collected while the computer system 824 of interest is operating. In this case, since the computer system 824 is not operating under training conditions, it is not known if or when the computer system 824 possesses the property or does not possess the property.

With respect to the statistical processing phase at 826, the set of the input data traces 114 at 822 may be used to compute various statistics. These statistics values may then be embodied within a statistics data structure object, and then passed onwards to the analytic processing stage (i.e., 828) that uses the trace classifier 112 at 814.

With respect to processing by the analytics module 122 at 828, the analytics module 122 may apply the learned trace classifier 112 to the given (unlabeled) statistics data objects from the statistical processing phase at 826. As a result, the trace classifier 112 may output at 830 (e.g., the detection output 124) either a 1 or 0, thus providing an approximate assessment of whether the input data information 118 satisfies the property or not. The output at 830 may be forwarded onto further management consoles, which may then issue alarms and initiate other needed actions as appropriate.

For the apparatus 100, with respect to support for Boolean system properties, the apparatus 100 may use statistical properties of quantitative data. In some cases, Boolean inputs that report the presence or absence of a particular property (e.g., of a string) may be included. These Boolean inputs may constitute atomic logical formulae, and may be supported by direct insertion into the genome. Mutation on these formulae may be restricted to negation and choice of the Boolean property.

For the apparatus 100, with respect to support for parameterized statistical properties, the parameters to statistical properties may be modified as part of the genetic process. The ACF has as its parameter the lag k at which the autocorrelation is computed. In this regard, the lag k may be randomly select during the mutation step. In this regard, values may be cached and ranges of values may be pre-computed to minimize performance impact.

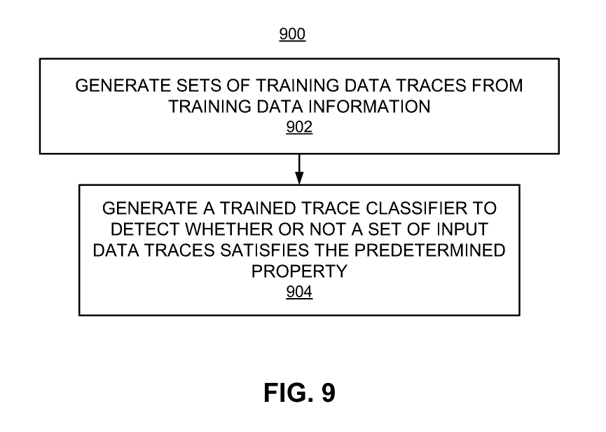

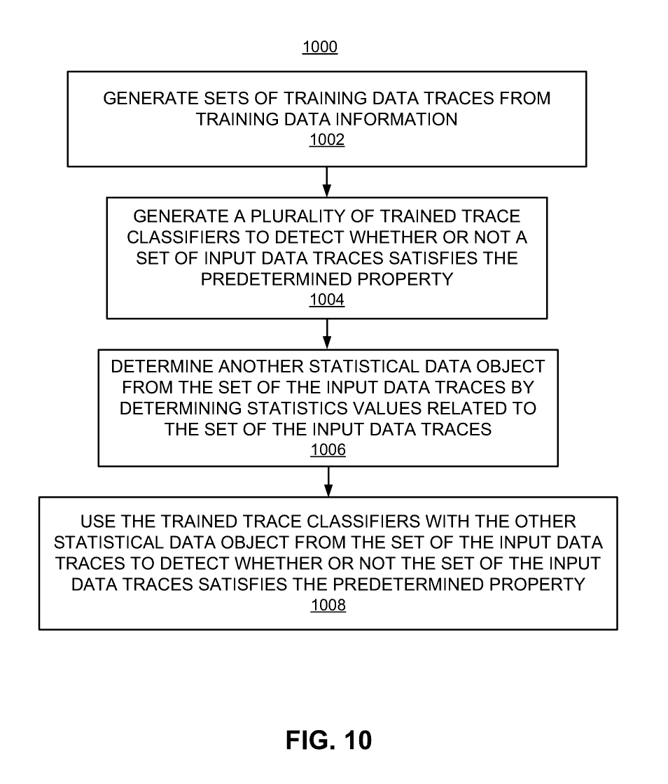

FIGS. 9 and 10 respectively illustrate flowcharts of methods 900 and 1000 for statistics-based data trace classification, corresponding to the example of the statistics-based data trace classification apparatus 100 whose construction is described in detail above. The methods 900 and 1000 may be implemented on the statistics-based data trace classification apparatus 100 with reference to FIGS. 1-8 by way of example and not limitation. The methods 900 and 1000 may be practiced in other apparatus.

Referring to FIG. 9, for the method 900, at block 902, the method may include generating sets of training data traces from training data information by assigning a subset of the training data information that has a predetermined property with a first label and assigning another subset of the training data information that does not have the predetermined property with a second label. For example, referring to FIG. 1, the training data trace generation module 102 may generate sets of training data traces 104 from training data information 106 by assigning a subset of the training data information 106 that has a predetermined property with a first label and assigning another subset of the training data information 106 that does not have the predetermined property with a second label.

At block 904, the method may include generating a trained trace classifier to detect whether or not a set of input data traces satisfies the predetermined property. For example, referring to FIG. 1, the trace classifier generation module 110 may generate the trained trace classifier 112 to detect whether or not the set of the input data traces 114 satisfies the predetermined property. The trace classifier may be trained to learn the predetermined property from a statistical data object determined from the sets of the training data traces, and the first and second labels related to the sets of the training data traces. The trace classifier may be a Boolean-valued expression that generates a first output if the set of the input data traces satisfies the predetermined property and a second value if the set of the input data traces does not satisfy the predetermined property.

According to an example, the method 900 may include determining the statistical data object from the sets of the training data traces by determining statistics values related to the sets of the training data traces. For example, referring to FIG. 1, the statistical training data trace processing module 108 may determine the statistical data object from the sets of the training data traces 104 by determining statistics values related to the sets of the training data traces 104.

According to an example, the method 900 may include determining another statistical data object from the set of the input data traces by determining statistics values related to the set of the input data traces. For example, referring to FIG. 1, the statistical input data trace processing module 120 may determine another statistical data object from the set of the input data traces 114 by determining statistics values related to the set of the input data traces 114.

According to an example, the method 900 may include using the trained trace classifier with the other statistical data object from the set of the input data traces to detect whether or not the set of the input data traces satisfies the predetermined property. For example, referring to FIG. 1, the analytics module 122 may use the trained trace classifier 112 with the other statistical data object from the set of the input data traces 114 to detect whether or not the set of the input data traces 114 satisfies the predetermined property.

Referring to FIG. 10, for the method 1000, at block 1002, the method may include generating sets of training data traces from training data information by assigning a subset of the training data information that has a predetermined property with a first label and assigning another subset of the training data information that does not have the predetermined property with a second label.

At block 1004, the method may include generating a plurality of trained trace classifiers to detect whether or not a set of input data traces satisfies the predetermined property. The trace classifiers may be trained to learn the predetermined property from a statistical data object determined from the sets of the training data traces, and the first and second labels related to the sets of the training data traces.

At block 1006, the method may include determining another statistical data object from the set of the input data traces by determining statistics values related to the set of the input data traces. For example, referring to FIG. 1, the statistical input data trace processing module 120 may determine another statistical data object from the set of the input data traces 114 by determining statistics values related to the set of the input data traces 114.

At block 1008, the method may include using the trained trace classifiers with the other statistical data object from the set of the input data traces to detect whether or not the set of the input data traces satisfies the predetermined property. For example, referring to FIG. 1, the analytics module 122 may use the trained trace classifiers with the other statistical data object from the set of the input data traces 114 to detect whether or not the set of the input data traces 114 satisfies the predetermined property.

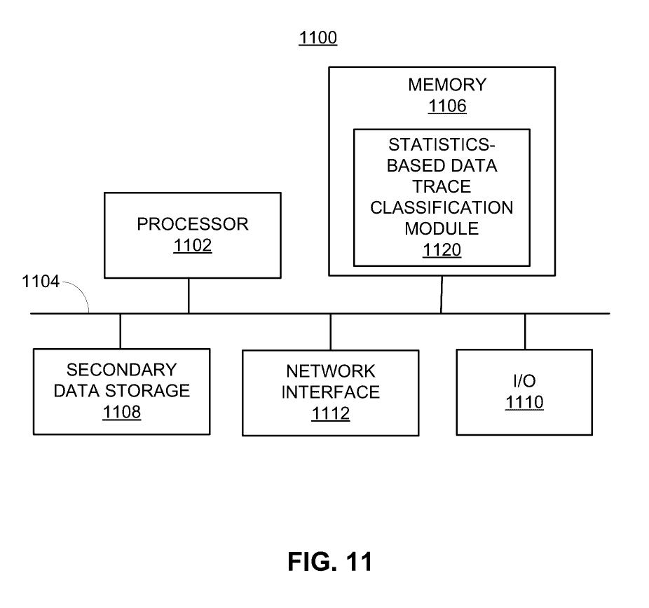

FIG. 11 shows a computer system 1100 that may be used with the examples described herein. The computer system 1100 may represent a generic platform that includes components that may be in a server or another computer system. The computer system 1100 may be used as a platform for the apparatus 100. The computer system 1100 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 1100 may include a processor 1102 that may implement or execute machine readable instructions performing some or all of the methods, functions and other processes described herein. Commands and data from the processor 1102 may be communicated over a communication bus 1104. The computer system may also include a main memory 1106, such as a random access memory (RAM), where the machine readable instructions and data for the processor 1102 may reside during runtime, and a secondary data storage 1108, which may be non-volatile and stores machine readable instructions and data. The memory and data storage are examples of computer readable mediums. The memory 1106 may include a statistics-based data trace classification module 1120 including machine readable instructions residing in the memory 1106 during runtime and executed by the processor 1102. The statistics-based data trace classification module 1120 may include the modules of the apparatus 100 shown in FIG. 1.

The computer system 1100 may include an I/O device 1110, such as a keyboard, a mouse, a display, etc. The computer system may include a network interface 1112 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A non-transitory computer readable medium having stored thereon machine readable instructions to provide statistics-based data trace classification, the machine readable instructions, when executed, cause at least one processor to:
generate sets of training data traces from training data information by assigning a subset of the training data information that has a predetermined property with a first label and assigning another subset of the training data information that does not have the predetermined property with a second label; and
generate a trained trace classifier to detect whether or not a set of input data traces satisfies the predetermined property, wherein the trace classifier is trained to learn the predetermined property from a statistical data object determined from the sets of the training data traces, and the first and second labels related to the sets of the training data traces.

2. The non-transitory computer readable medium of claim 1, wherein the machine readable instructions, when executed, further cause the at least one processor to:
determine the statistical data object from the sets of the training data traces by determining statistics values related to the sets of the training data traces, wherein the statistics values include at least one of mean, variance, median, squared coefficient of variation (SCV), autocorrelation, and quantile.

3. The non-transitory computer readable medium of claim 1, wherein the trace classifier is a Boolean-valued expression that generates a first output if the set of the input data traces satisfies the predetermined property and a second value if the set of the input data traces does not satisfy the predetermined property.

4. The non-transitory computer readable medium of claim 1, wherein the machine readable instructions, when executed, further cause the at least one processor to:
determine another statistical data object from the set of the input data traces by determining statistics values related to the set of the input data traces, wherein the statistics values include at least one of mean, variance, median, squared coefficient of variation (SCV), autocorrelation, and quantile.

5. The non-transitory computer readable medium of claim 4, the machine readable instructions, when executed, further cause the at least one processor to:
use the trained trace classifier with the other statistical data object from the set of the input data traces to detect whether or not the set of the input data traces satisfies the predetermined property.

6. The non-transitory computer readable medium of claim 1, wherein the predetermined property is related to at least one of operating system detection, application start-up detection, and malware detection.

7. A statistics-based data trace classification apparatus comprising:
at least one processor;
a training data trace generation module, executed by the at least one processor, to generate sets of training data traces from training data information by assigning a subset of the training data information that has a predetermined property with a first label and assigning another subset of the training data information that does not have the predetermined property with a second label;
a trace classifier generation module, executed by the at least one processor, to generate a trained trace classifier to detect whether or not a set of input data traces satisfies the predetermined property, wherein the trace classifier is trained to learn the predetermined property from a statistical data object determined from the sets of the training data traces, and the first and second labels related to the sets of the training data traces; and
an analytics module, executed by the at least one processor, to use the trained trace classifier to detect whether or not the set of the input data traces satisfies the predetermined property.

8. The statistics-based data trace classification apparatus according to claim 7, further comprising:
a statistical input data trace processing module, executed by the at least one processor, to determine another statistical data object from the set of the input data traces by determining statistics values related to the set of the input data traces, wherein the statistics values include at least one of mean, variance, median, squared coefficient of variation (SCV), autocorrelation, and quantile.

9. The statistics-based data trace classification apparatus according to claim 8, wherein to use the trained trace classifier to detect whether or not the set of the input data traces satisfies the predetermined property, the analytics module is further executed by the at least one processor to:
use the trained trace classifier with the other statistical data object from the set of the input data traces to detect whether or not the set of the input data traces satisfies the predetermined property.

10. The statistics-based data trace classification apparatus according to claim 7, further comprising:
a statistical training data trace processing module, executed by the at least one processor, to determine the statistical data object from the sets of the training data traces by determining statistics values related to the sets of the training data traces, wherein the statistics values include at least one of mean, variance, median, squared coefficient of variation (SCV), autocorrelation, and quantile.

11. The statistics-based data trace classification apparatus according to claim 7, wherein the trace classifier is a Boolean-valued expression that generates a first output if the set of the input data traces satisfies the predetermined property and a second value if the set of the input data traces does not satisfy the predetermined property.

12. The statistics-based data trace classification apparatus according to claim 7, wherein the predetermined property is related to at least one of operating system detection, application start-up detection, and malware detection.

13. A method for statistics-based data trace classification, the method comprising:
generating sets of training data traces from training data information by assigning a subset of the training data information that has a predetermined property with a first label and assigning another subset of the training data information that does not have the predetermined property with a second label;
generating a plurality of trained trace classifiers to detect whether or not a set of input data traces satisfies the predetermined property, wherein the trace classifiers are trained to learn the predetermined property from a statistical data object determined from the sets of the training data traces, and the first and second labels related to the sets of the training data traces;
determining another statistical data object from the set of the input data traces by determining statistics values related to the set of the input data traces; and
using the trained trace classifiers with the other statistical data object from the set of the input data traces to detect whether or not the set of the input data traces satisfies the predetermined property.

14. The method according to claim 13, wherein the trace classifiers are Boolean-valued expressions that generate a first output if the set of the input data traces satisfies the predetermined property and a second value if the set of the input data traces does not satisfy the predetermined property.

15. The method according to claim 13, wherein the predetermined property is related to at least one of operating system detection, application start-up detection, and malware detection.
